(19) United States
(12) Patent Application Publication
(10) Pub. No.: US 2025/0074557 A1
(43) Pub. Date: Mar. 6, 2025

(54) CONTROL DEVICE AND CONTROL METHOD

(71) Applicant: TOYOTA JIDOSHA KABUSHIKI KAISHA, Toyota-shi (JP)

(72) Inventors: Yoshihisa SHINODA, Toyota-shi (JP); Naoyuki TSUZUKI, Toyota-shi (JP); Isao KOBAYASHI, Toyota-shi (JP); Yasutaka NISHIMURA, Nisshin-shi (JP)

(73) Assignee: TOYOTA JIDOSHA KABUSHIKI KAISHA, Toyota-shi (JP)

(21) Appl. No.: 18/799,105

(22) Filed: Aug. 9, 2024

(30) Foreign Application Priority Data
Sep. 1, 2023 (JP) 2023-142470

(51) Int. Cl. B63B 49/00

(52) U.S. Cl. CPC B63B 49/00

(57) ABSTRACT

A control device mounted on a ship includes a control unit. The control unit is configured to set a first water area in which automatic pilot for berthing the ship at a berthing location for the ship is able to start when the berthing location is selected. The control unit is configured to display the berthing location and the first water area on a display screen provided in the ship together with map information.

### CROSS-REFERENCE TO RELATED APPLICATION

This application claims priority to Japanese Patent Application No. 2023-142470 filed on Sep. 1, 2023, incorporated herein by reference in its entirety.

### BACKGROUND

### 1. Technical Field

The present disclosure relates to a control device and a control method.

### 2. Description of Related Art

There has hitherto been known a technique related to ship berthing control. Japanese Unexamined Patent Application Publication No. 2020-40470 (JP 2020-40470 A), for example, discloses a technique of assisting operation to berth a ship.

### SUMMARY

Ship berthing control cannot be started before a ship enters a water area in a predetermined range from a berthing location. However, a ship operator cannot grasp a water area in which berthing control can be performed. Thus, there is room for improvement with the technique related to ship berthing control.

The present disclosure is directed to improving the technique related to ship berthing control.

A first aspect of the present disclosure provides a control device mounted on a ship, including a control unit. The control unit is configured to set a first water area in which automatic pilot for berthing the ship at a berthing location for the ship is able to start when the berthing location is selected. The control unit is configured to display the berthing location and the first water area on a display screen provided in the ship together with map information.

In the control device according to the first aspect of the present disclosure, the control unit may be configured to acquire information on a position of the ship and a stem direction of the ship. The control unit may be configured to extract, based on the information, one or more registered locations at which the ship is able to be berthed. The control unit may be configured to display the one or more registered locations on the display screen.

In the control device according to the first aspect of the present disclosure, the control unit may be configured to accept that the berthing location is selected when one of the one or more registered locations is selected as the berthing location for the ship.

In the control device according to the first aspect of the present disclosure, the first water area may be a water area defined such that, when a first circle is equally divided into two semicircles by a line parallel to a stem direction of the ship berthed on a starboard side or on a port side, a range of the water area occupies an inside of one of the two semicircles on a sea side. The first circle may be a circle having a predetermined radius and centered at a location that is a predetermined distance away in a first direction from the berthing location. The first direction may be a direction on the sea side and orthogonal to the stem direction.

In the control device according to the first aspect of the present disclosure, the control unit may be configured to set a second water area when an obstacle is detected in the first water area. The second water area is obtained by removing a region in which the obstacle is present from the first water area. The control unit may be configured to display the set second water area on the display screen in place of the first water area.

In the control device according to the first aspect of the present disclosure, the obstacle may be an artificial structure, a region in which berthing is topographically or legally not allowed, or an object that is detected by a sensor provided in the ship and that obstructs navigation of the ship. The artificial structure may include a pier, a quay, or a buoy displayed on the display screen.

In the control device according to the first aspect of the present disclosure, the control unit may be configured to set a part of the first water area or a part of the second water area as a third water area in which the automatic pilot is started. The part of the first water area or the part of the second water area may be determined according to a stem direction of the ship with the ship berthed The control unit may be configured to display the third water area on the display screen in place of the first water area or the second water area.

In the control device according to the first aspect of the present disclosure, the third water area may be a water area defined such that, when a fourth water area is equally divided into two quadrants by a line segment, a range of the water area occupies an inside of one of the two quadrants on a stern side. The fourth water area may be a water area defined such that, when a second circle is equally divided into two semicircles by a line parallel to the stem direction with the ship berthed on a starboard side or on a port side, a range of the water area occupies an inside of one of the two semicircles on a sea side. The first circle may be a circle having a predetermined radius and centered at a location a predetermined distance away in a first direction from the berthing location. The first direction may be a direction on the sea side and orthogonal to the stem direction. The line segment may pass through the berthing location and be orthogonal to the stem direction with the ship berthed.

In the control device according to the first aspect of the present disclosure, the third water area may be determined according to whether the ship is berthed at the berthing location on a starboard side or on a port side.

In the control device according to the first aspect of the present disclosure, the control unit may be configured to display a position of the ship and a stem direction of the ship on the display screen together with the map information.

A second aspect of the present disclosure provides a control method executed by a control device mounted on a ship. The control method includes: setting a first water area in which automatic pilot for berthing the ship at a berthing location for the ship is able to start when the berthing location is selected; and displaying the berthing location and the first water area on a display screen provided in the ship together with map information.

The control method according to the second aspect of the present disclosure may further include: acquiring information on a position of the ship and a stem direction of the ship; extracting, based on the information, one or more registered locations at which berthing of the ship is able to be berthed; and displaying the one or more registered locations on the display screen.

The control method according to the second aspect of the present disclosure may further include accepting that the berthing location is selected when one of the one or more registered locations is selected as the berthing location for the ship.

In the control method according to the second aspect of the present disclosure, the first water area may be a water area defined such that, when a first circle is equally divided into two semicircles by a line parallel to a stem direction of the ship berthed on a starboard side or on a port side, a range of the water area occupies an inside of one of the two semicircles on a sea side. The first circle may be a circle having a predetermined radius and centered at a location that is a predetermined distance away in a first direction from the berthing location. The first direction may be a direction on the sea side and orthogonal to the stem direction.

The control method according to the second aspect of the present disclosure may further include: setting a second water area when an obstacle is detected in the first water area; and displaying the set second water area on the display screen in place of the first water area. The second water area may be obtained by removing a region in which the obstacle is present from the first water area.

In the control method according to the second aspect of the present disclosure, the obstacle may be an artificial structure, a region in which berthing is topographically or legally not allowed, or an object that is detected by a sensor provided in the ship and that obstructs navigation of the ship. The artificial structure may include a pier, a quay, or a buoy displayed on the display screen.

The control method according to the second aspect of the present disclosure may further include: setting a part of the first water area or a part of the second water area as a third water area in which the automatic pilot is started; and displaying the set third water area on the display screen in place of the first water area or the second water area. The part of the first water area or the part of the second water area may be determined according to a stem direction of the ship with the ship berthed.

In the control method according to the second aspect of the present disclosure, the third water area may be a water area defined such that, when a fourth water area is equally divided into two quadrants by a line segment, a range of the water area occupies an inside of one of the two quadrants on a stern side. The fourth water area may be a water area defined such that, when a first circle is equally divided into two semicircles by a line parallel to the stem direction with the ship berthed on a starboard side or on a port side, a range of the water area occupies an inside of one of the two semicircles on a sea side. The first circle may be a circle having a predetermined radius and centered at a location a predetermined distance away in a first direction from the berthing location. The first direction may be a direction on the sea side and orthogonal to the stem direction. The line segment may pass through the berthing location and be orthogonal to the stem direction with the ship berthed.

In the control method according to the second aspect of the present disclosure, the third water area may be determined according to whether the ship is berthed at the berthing location on a starboard side or on a port side.

In the control method according to the second aspect of the present disclosure, the control device may display a position of the ship and a stem direction of the ship on the display screen together with the map information.

According to one embodiment of the present disclosure, the technique related to ship berthing control is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a schematic configuration of a system according to an embodiment of the present disclosure;

FIG. 2 is a flowchart illustrating an example of operation of a control device;

FIG. 3 is a schematic diagram illustrating an example of the names of portions of a ship;

FIG. 4 is a schematic diagram illustrating an example of a first water area;

FIG. 5 is a schematic diagram illustrating an example of a second water area;

FIG. 6 is a schematic diagram illustrating an example of a third water area; and

FIG. 7 is a schematic diagram illustrating an example of the third water area.

### DETAILED DESCRIPTION OF EMBODIMENTS

An embodiment of the present disclosure will be described below.

### Overview of Embodiment

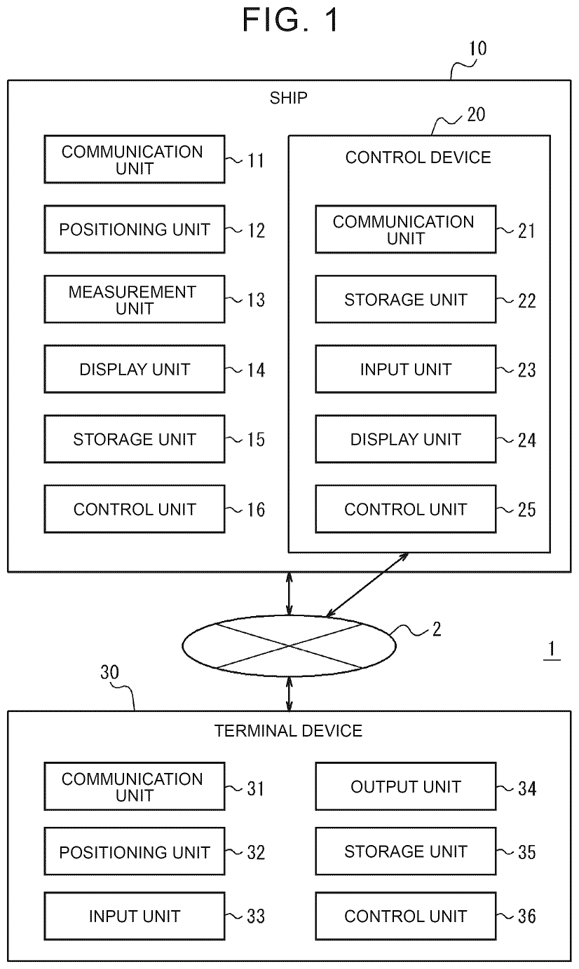

An overview of a system 1 according to an embodiment of the present disclosure will be described with reference to FIG. 1. The system 1 includes a ship 10, a control device 20, and a portable terminal 30. The ship 10, the control device 20, and the portable terminal 30 are connected to be communicable with a network 2 including the

Internet and a mobile communication network, for example.

The ship 10 includes the control device 20. The ship 10 is connected to be communicable with the control device 20 through a wire. The ship 10 may be connected to be communicable with the control device 20 via the network 2.

The control device 20 is a computer provided in the ship 10. The control device 20 executes automatic pilot for berthing the ship 10 at a berthing location. The control device 20 is communicable with the ship 10 through a wire. The control device 20 is also communicable with the ship 10 and the portable terminal 30 via the network 2.

The portable terminal 30 may be a cellular phone, a smartphone, a tablet, a personal computer (PC), etc. possessed by a ship operator, for example. The portable terminal 30 is connected to be communicable with the control device 20 via the network 2.

An overview of the present embodiment will be described first, and the details of the present embodiment will be discussed later. When a berthing location for the ship 10 is selected, the control device 20 sets a first water area in which automatic pilot for berthing the ship 10 at the selected berthing location is startable, and displays the selected berthing location and the set first water area on a display screen provided in the ship 10 together with map information.

In this manner, according to the present embodiment, a water area in which automatic pilot to a berthing location is startable is displayed on the display screen provided in the ship 10, even when the ship 10 is navigating outside such a water area. This enables the ship operator to clearly see a ship operation destination through display on the display screen, and to grasp the range of such a water area before start of automatic pilot. Thus, the technique related to ship berthing control is improved to improve the convenience for the ship operator to grasp the water area.

Next, components of the system 1 will be described in detail.

### Configuration of Ship

As illustrated in FIG. 1, the ship 10 includes a communication unit 11, a positioning unit 12, a measurement unit 13, a display unit 14, a storage unit 15, a control unit 16, and the control device 20. The control device 20 will be discussed in detail later.

The communication unit 11 includes both a communication interface connected to the network 2 and a communication interface connected to a communication unit 21 of the control device 20 through a wire. While the communication interface connected to the network 2 is compatible with a mobile communication standard such as 4th Generation (4G) or 5th Generation (5G), for example, this is not limiting, and the communication interface may be compatible with any communication standard. In the present embodiment, the ship 10 is connected to be communicable with the communication unit 21 of the control device 20 through a wire via the communication unit 11. Further, the ship 10 may be connected to be wirelessly communicable with the communication unit 21 of the control device 20 via the communication unit 11 and the network 2.

The positioning unit 12 includes one or more devices that acquire position information on the ship 10. Specifically, while the positioning unit 12 includes a receiver that supports the Global Positioning System (GPS), for example, this is not limiting, and the positioning unit 12 may include a receiver that supports any satellite positioning system.

The measurement unit 13 includes one or more sensors. The measurement unit 13 may include a sonar, a radar, a gyro compass, a magnetic compass, an acceleration sensor, an atmospheric pressure sensor, etc. However, the measurement unit 13 may include other sensors.

The display unit 14 is configured to include at least one display interface that can display characters or an image. While the display unit 14 may be a chart plotter, for example, this is not limiting. The display interface may be a display such as a liquid crystal display (LCD) or an organic electroluminescence (EL) display, for example. However, the display interface is not limited thereto. The display unit 14 displays information such as a berthing location for the ship 10 and water areas, for example, together with map information.

The storage unit 15 includes one or more memories. While the memory may be a semiconductor memory, a magnetic memory, or an optical memory, for example, these are not limiting. The memory included in the storage unit 15 may function as a main storage device, an auxiliary storage device, or a cache memory, for example. The storage unit 15 stores any information to be used for operation of the ship 10. For example, the storage unit 15 may store a system program, an application program, embedded software, map information, a list of berthing locations, etc. The information stored in the storage unit 15 may be updatable with information acquired from the network 2 via the communication unit 11, for example.

The control unit 16 includes one or more processors, one or more programmable circuits, one or more dedicated circuits, and a combination of these. While the processor may be a general-purpose processor such as a central processing unit (CPU) or a graphics processing unit (GPU) or a dedicated processor specialized for specific processing, for example, these are not limiting. While the programmable circuit may be a field-programmable gate array (FPGA), for example, this is not limiting. While the dedicated circuit may be an application specific integrated circuit (ASIC), for example, this is not limiting. The control unit 16 controls operation of the entire ship 10.

### Configuration of Control Device

As illustrated in FIG. 1, the control device 20 includes a communication unit 21, a storage unit 22, an input unit 23, a display unit 24, and a control unit 25.

The communication unit 21 includes both a communication interface connected to the network 2 and a communication interface connected to the communication unit 11 of the ship 10 through a wire. While the communication interface connected to the network 2 is compatible with a mobile communication standard such as 4G or 5G, for example, this is not limiting, and the communication interface may be compatible with any communication standard. In the present embodiment, the control device 20 is connected to be communicable with the communication unit 11 of the ship 10 through a wire via the communication unit 21. Further, the control device 20 may be connected to be wirelessly communicable with the communication unit 11 of the ship 10 and a communication unit 31 of the portable terminal 30 via the communication unit 21 and the network 2.

The storage unit 22 includes one or more memories. The memory included in the storage unit 22 may function as a main storage device, an auxiliary storage device, or a cache memory, for example. The storage unit 22 stores any information to be used for operation of the control device 20. For example, the storage unit 22 may store a system program, an application program, a database, map information, a list of registered locations at which berthing is possible, a selected berthing location for the ship 10 (expected berthing location), etc. The information stored in the storage unit 22 may be updatable with information acquired from the network 2 via the communication unit 21, for example.

The input unit 23 is configured to include at least one input interface that can receive input by an operator of the ship 10. The input interface may be a physical key, a capacitive key, a pointing device, a camera, a touch screen provided integrally with a display of the display unit 24 to be discussed later, or a microphone that picks up voice from the operator, for example. However, the input interface is not limited thereto.

The display unit 24 is configured to include at least one display interface that can display characters or an image. The display interface may be a display such as a liquid crystal display (LCD) or an organic electroluminescence (EL) display, for example. However, the display interface is not limited thereto. The display unit 24 displays information such as a selection list of candidates for berthing locations for the ship 10, for example. The display unit 24 may have a function of displaying information such as a berthing location for the ship 10 and water areas together with map information.

The control unit 25 includes one or more processors, one or more programmable circuits, one or more dedicated circuits, and a combination of these. The control unit 25 controls operation of the entire control device 20.

### Configuration of Portable Terminal

As illustrated in FIG. 1, the portable terminal 30 includes a communication unit 31, a positioning unit 32, an input unit 33, an output unit 34, a storage unit 35, and a control unit 36.

The communication unit 31 is configured to include at least one communication module that is connectable to the network 2. The communication module may be a communication module that is compatible with a mobile communication standard such as Long Term Evolution (LTE), 4G, or 5G, for example. However, the communication module is not limited thereto. The communication module may be compatible with any communication standard.

The positioning unit 32 can acquire position information on the portable terminal 30. The positioning unit 32 is configured to include at least one reception module that supports a satellite positioning system. The reception module may be a reception module that supports the GPS, for example. However, the reception module is not limited thereto. The reception module may be a reception module that supports any satellite positioning system.

The input unit 33 is configured to include at least one input interface that can receive input by an operator of the ship 10. The input interface may be a physical key, a capacitive key, a pointing device, a touch screen provided integrally with a display, or a microphone, for example. However, the input interface is not limited thereto.

The output unit 34 can output data. The output unit 34 is configured to include at least one output interface that can output data. The output interface may be a display or a speaker, for example. The display may be an LCD, an organic EL display, etc., for example. However, the output interface is not limited thereto.

The storage unit 35 includes one or more memories. While the memory may be a semiconductor memory, a magnetic memory, or an optical memory, for example, these are not limiting. The memory included in the storage unit 35 may function as a main storage device, an auxiliary storage device, or a cache memory, for example. The storage unit 35 stores any information to be used for operation of the portable terminal 30. For example, the storage unit 35 may store a system program, an application program, embedded software, etc. The storage unit 35 may store an application program that displays information such as a berthing location for the ship 10 and water areas, for example, together with map information. The information stored in the storage unit 35 may be updatable with information acquired from the network 2 via the communication unit 31, for example.

The control unit 36 is configured to include at least one processor, at least one dedicated circuit, or a combination of these. The control unit 36 executes a process related to operation of the portable terminal 30 while controlling the various units of the portable terminal 30.

### Operation Flow of Control Device

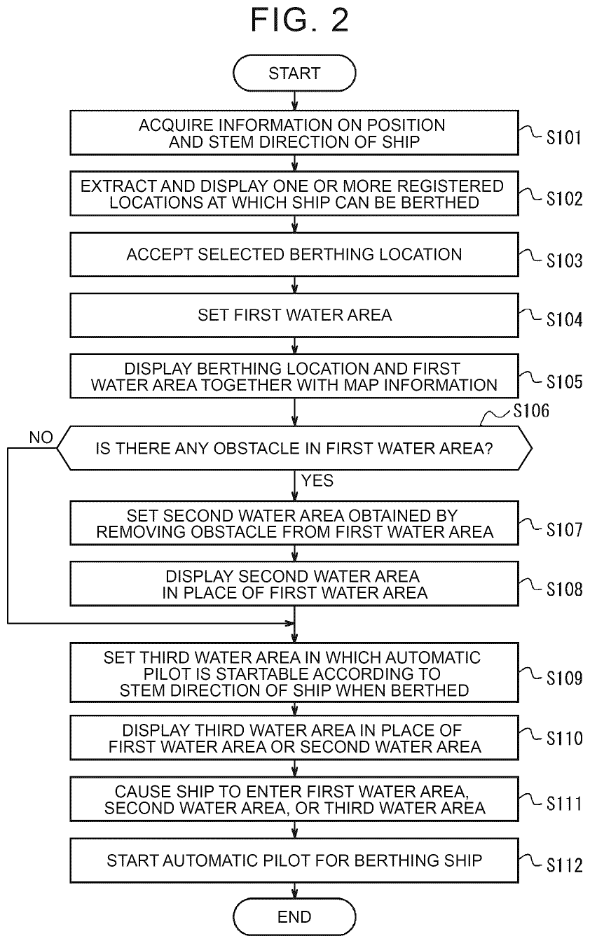

Operation of the control device 20 according to the present embodiment will be described with reference to FIG. 2. This operation relates to setting and display of a water area in which automatic pilot for berthing the ship 10 at a selected berthing location is startable.

In S101, the control unit 25 acquires information on a position p1 and a stem direction d of the ship 10.

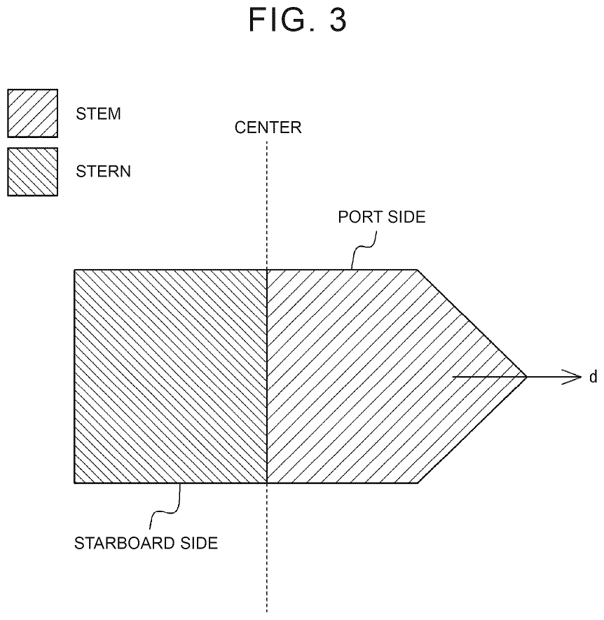

FIG. 3 is a schematic diagram illustrating an example of the names of portions of the ship 10. In the present disclosure, the front half of a hull of the ship 10 is called “stem”, the rear half of the hull is called “stern”, the right side surface (broad side) of the hull is called “starboard side”, and the left side surface (broad side) of the hull is called “port side”. The stem direction d of the ship 10 will be discussed later. While the ship 10 is described as navigating in a sea 3 in the present disclosure, the ship 10 may navigate in water areas other than the sea, such as a lake, a canal, and a river.

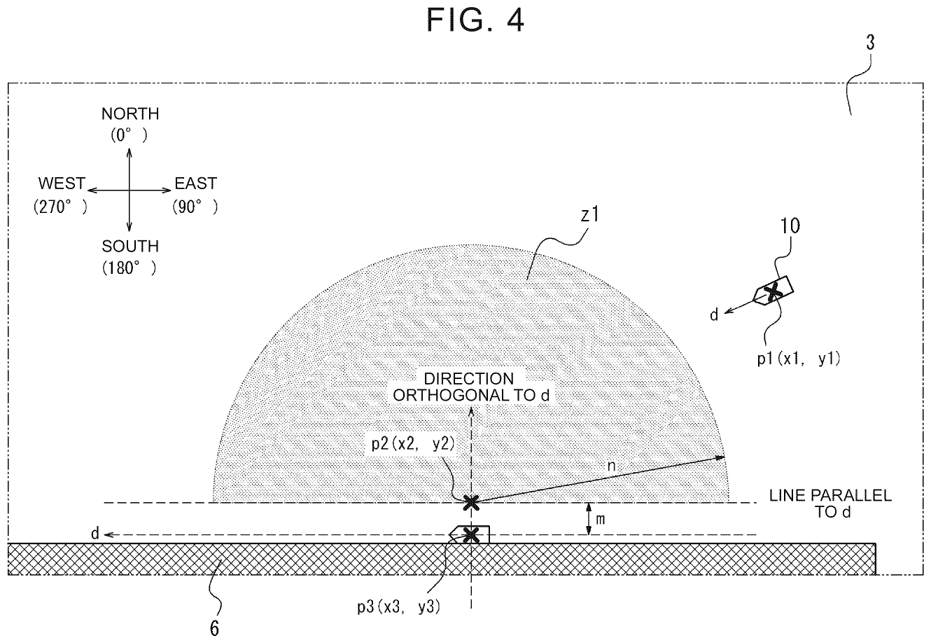

FIG. 4 is a schematic diagram illustrating an example of a first water area z1. As illustrated in FIG. 4, information on the position p1 of the ship 10 includes coordinates (x1, y1) of the latitude and the longitude of a location at which the ship 10 is positioned. The positioning unit 12 of the ship 10 acquires information on the position p1 (x1, y1) of the ship 10 using a receiver that supports the GPS, for example.

As illustrated in FIG. 4, meanwhile, information on the stem direction d of the ship 10 includes an azimuth angle at which the stem of the ship 10 indicated by an arrow is directed. When the direction of the north is defined as 0°, the stem direction d of the ship 10 is measured rightward up to 360° from the direction of the north. While the stem direction d is measured using a GPS compass, the measurement method is not limited thereto. The GPS compass is a device that observes differences in phase among carrier radio waves (carriers) from GPS satellites using a plurality of GPS antennas to calculate the direction (referred to as baseline vector) of the antennas with respect to a reference antenna with high precision. The stem direction d of the ship 10 may be measured using a gyro compass or a magnetic compass.

In S102, the control unit 25 extracts one or more registered locations at which berthing of the ship 10 is possible based on the information on the position p1 and the stem direction d of the ship 10, and displays the extracted one or more registered locations at which berthing of the ship 10 is possible on a display screen provided in the ship 10.

The control unit 25 searches for one or more registered locations at a short distance from the ship 10 and saved in the storage unit 22 based on the position p1 and the stem direction d of the navigating ship 10, and displays the extracted one or more registered locations at which berthing of the ship 10 is possible on a display screen of the display unit 14 of the ship 10. The control unit 25 transmits information on the one or more registered locations to the display unit 14 of the ship 10 via the communication unit 21 and the communication unit 11 of the ship 10. In addition, the control unit 25 may display information on the one or more registered locations on a display screen of the display unit 24 of the control device 20 provided in the ship 10.

In S103, when one of the one or more registered locations is selected as a berthing location p3 (x3, y3) for the ship 10, the control unit 25 accepts the selected berthing location p3 (x3, y3).

The control unit 25 saves the accepted berthing location p3 (x3, y3) in the storage unit 22.

In S104, when the berthing location p3 for the ship 10 is selected, the control unit 25 sets a first water area z1 in which automatic pilot for berthing the ship 10 at the selected berthing location p3 is startable.

FIG. 4 is a schematic diagram illustrating an example of a first water area z1. As illustrated in FIG. 4, the first water area z1 is a water area defined such that, when a circle having a predetermined radius n and centered at a location p2 (x2, y2) a predetermined distance m away from the berthing location p3 (x3, y3) in a direction on the sea side and orthogonal to the stem direction d with the ship 10 berthed on the starboard side or on the port side is equally divided into two semicircles by a line parallel to the stem direction d, the range of the water area occupies the inside of one of the semicircle on the sea side. The predetermined distance m and the radius n of the semicircles have values determined by a distance at which berthing operation is startable and which is based on the precision of a device provided in the positioning unit 12 to measure the position of the ship 10 and the size of the ship 10. The location p2 (x2, y2) is a stop location at which the ship 10 having entered the first water area z1 is temporarily stopped before being berthed.

In S105, the control unit 25 displays the selected berthing location p3 and the set first water area z1 on a display screen provided in the ship 10 together with map information.

The control unit 25 transmits information on the selected berthing location p3 and the set first water area z1 to the display unit 14 of the ship 10 via the communication unit 21 and the communication unit 11 of the ship 10.

The display unit 14 of the ship 10 may be a chart plotter, for example. The chart plotter is an electronic device mounted for the purpose of navigating the ship 10, and displays the position p1, the stem direction d, the speed, etc. of the host ship on an electronic nautical chart. In addition, the chart plotter can additionally display meteorologic information, a wind velocity, a tide, a water depth, and information acquired by a fish finder or various sensors. The display unit 14 of the ship 10 can display map information. The map information includes a map of water areas and costal areas all over the country or in a predetermined region.

In addition, the display unit 24 of the control device 20 may have a function of displaying the selected berthing location p3 and the set first water area z1 together with the map information. In such a case, the “display screen provided in the ship 10” may include the display unit 24 of the control device 20 mounted on the ship 10, in addition to the display unit 14 of the ship 10. The display unit 24 displays the selected berthing location p3 and the set first water area z1 on a display screen together with the map information.

Further, the control unit 25 may transmit information on the berthing location p3 for the ship 10 and the first water area z1, together with the map information, to the output unit 34 via the communication unit 31 of the portable terminal 30 that can start an application program for displaying such information. In such a case, the berthing location p3 and the first water area z1 are displayed on a display (output unit 34) of the portable terminal 30 together with the map information. This further improves the convenience for the ship operator to grasp the first water area z1 as a ship operation destination.

The control unit 25 may display the position p1 and the stem direction d of the ship 10 on the display unit 14, the display unit 24, or a display screen of the output unit 34 together with the map information. This renders the ship operation destination for the ship 10 clearer.

In S106, the control unit 25 monitors the presence or absence of any obstacle in the first water area z1.

The obstacle may be an artificial structure including a pier (quay) 6, a land 4, and a buoy 5, a region in which berthing is topographically or legally not allowed, or an object that is detected by a sensor provided in the ship 10 and that obstructs the navigation of the ship 10, displayed on the display screen.

In S107, when an obstacle is detected in the first water area z1, the control unit 25 sets a second water area z2 by removing a region in which the obstacle is present from the first water area z1.

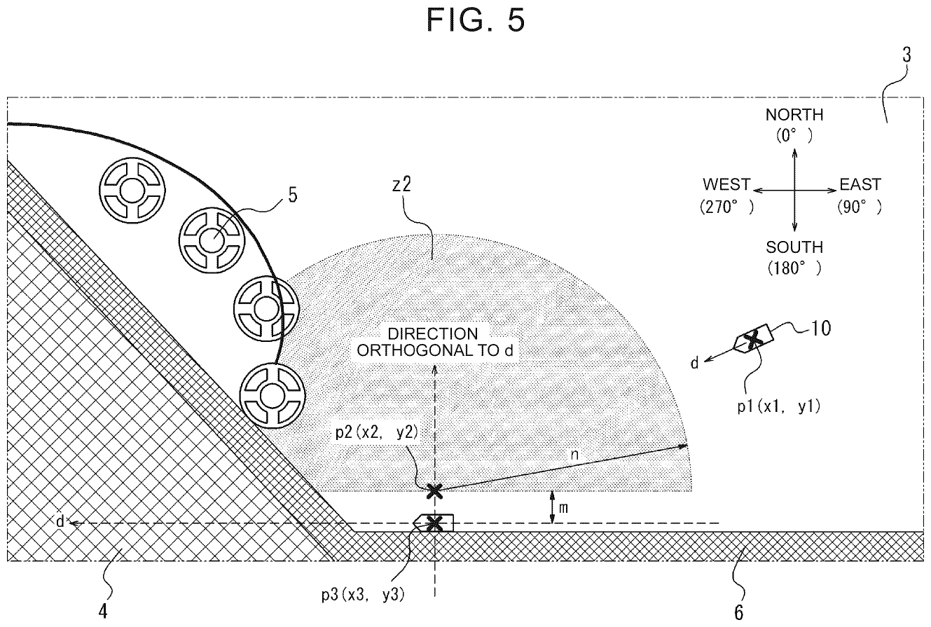

FIG. 5 is a schematic diagram illustrating an example of the second water area z2. As illustrated in FIG. 5, the second water area 22 is set by removing a region in which an artificial structure such as the pier (quay) 6, the land 4, and the buoy 5 is present from the first water area z1. The pier (quay) 6 and the region in which berthing is topographically or legally not allowed are acquired from the map information. Meanwhile, the object that floats in the sea 3 and obstructs the navigation of the ship 10 is detected by a sensor provided in the measurement unit 13 of the ship 10. While the sensor may be a sonar or a radar, for example, these are not limiting. The sonar is a device that is used as a fish finder in various ships. The radar is a device that measures an accurate distance to another ship or an object such as a floating object by emitting radio waves (microwaves), measuring the time before reflected waves are returned from such a ship or an object located on the line of travel of the radio waves, and converting the time into a distance.

In S108, the control unit 25 displays the second water area 22 on the display screen provided in the ship 10 in place of the first water area z1.

The control unit 25 may display the second water area 22 on the display unit 24 or the display screen of the output unit 34. The control unit 25 may display the position p1 and the stem direction d of the ship 10 on the display screen together with the map information. This renders the ship operation destination for the ship 10 clearer.

In S109, the control unit 25 sets a part of the first water area z1 or the second water area z2 determined according to the stem direction d of the ship 10 with the ship 10 berthed as a third water area z3 in which automatic pilot is startable.

The first water area z1 is a water area defined such that, when a circle having a predetermined radius n and centered at the location p2 a predetermined distance m away from the berthing location p3 in a direction on the sea side and orthogonal to the stem direction d with the ship 10 berthed on the starboard side or on the port side is equally divided into two semicircles by a line parallel to the stem direction d, the range of the water area occupies the inside of one of the semicircle on the sea side. The second water area 22 is a water area obtained by removing a region in which an obstacle such as the pier (quay) 6, the land 4, and the buoy 5 is present from the first water area z1. The third water area z3 is a water area defined such that, when the first water area z1 (a water area, the range of which occupies the inside of a semicircle on the sea side) or the second water area 22 (a water area obtained by removing an obstacle from the inside of a semicircle on the sea side) is equally divided into two quadrants by a line segment passing through the berthing location p3 and orthogonal to the stem direction d with the ship 10 berthed, the range of the water area occupies the inside of one of the quadrants on the stern side.

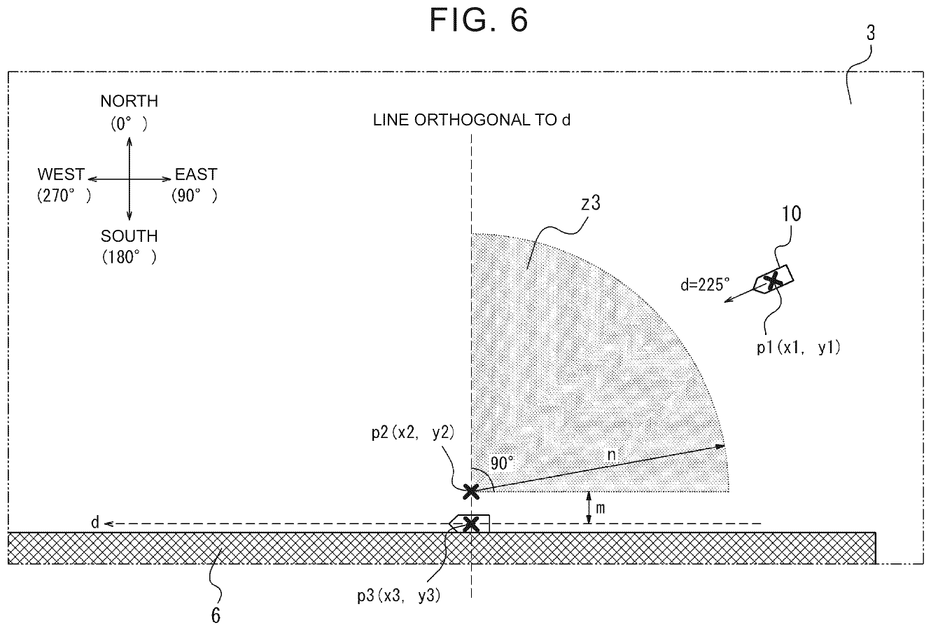

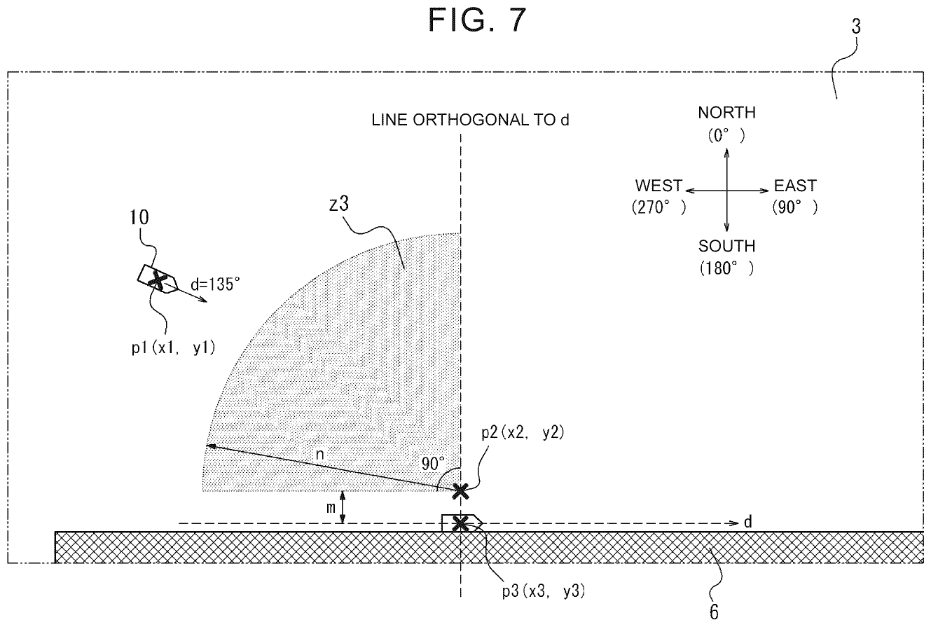

FIGS. 6 and 7 are each a schematic diagram illustrating an example of the third water area z3. As illustrated in FIGS. 6 and 7, the third water area z3 is determined according to whether the ship 10 is to be berthed on the starboard side or on the port side at the berthing location p3. FIG. 6 illustrates the third water area z3 set when the ship 10 having entered from the sea in the northeast direction is to be berthed with the stem direction d in the west direction (stem direction d=270°, for example. On the other hand, FIG. 7 illustrates the third water area z3 set when the ship 10 having entered from the sea in the northwest direction is to be berthed with the stem direction d in the cast direction (stem direction d=90°), for example. This enables the ship operator to understand that the range of a water area in which automatic pilot is startable is different according to the stem direction d at the time of berthing.

In S110, the control unit 25 displays the set third water area z3 on the display screen provided in the ship 10 in place of the first water area z1 or the second water area z2.

The control unit 25 may display the third water area z3 on the display unit 24 or the display screen of the output unit 34. As illustrated in FIGS. 6 and 7, the control unit 25 may display the position p1 and the stem direction d of the ship 10 on the display screen together with the map information. This renders the ship operation destination for the ship 10 clearer.

In S111, the control unit 25 causes the ship 10 to enter the first water area, the second water area, or the third water area.

In S112, when the ship 10 enters the first water area, the second water area, or the third water area, the control unit 25 starts automatic pilot for berthing the ship 10.

When a predetermined button provided in the input unit 23 or a predetermined icon displayed on a touch screen provided integrally with the display screen (display) of the display unit 24 is selected, a selection screen for a berthing location for the ship 10 is displayed. When a choice is received on the selection screen and the berthing location p3 saved in the storage unit 22 is selected, the control unit 25 starts automatic pilot for berthing the ship 10 at the selected berthing location p3.

As has been described above, when a berthing location for the ship 10 is selected, the control device 20 according to the present embodiment sets a first water area z1 in which automatic pilot for berthing the ship 10 at the selected berthing location p3 is startable, and displays the selected berthing location p3 and the set first water area z1 on the display screen provided in the ship 10 together with the map information.

In this manner, according to the present embodiment, a water area in which automatic pilot to the berthing location p3 is startable is displayed on the display screen provided in the ship 10, even when the ship 10 is navigating outside such a water area. This enables the ship operator to clearly see a ship operation destination through display on the display screen, and to grasp the range of such a water area before start of automatic pilot. Thus, the technique related to control for berthing the ship 10 is improved to improve the convenience for the ship operator to grasp the water area.

While the present disclosure has been described based on the drawings and the embodiment, it should be noted that a person skilled in the art may make a variety of modifications and alterations based on the present disclosure. Thus, it should be noted that such modifications and alterations are included in the scope of the present disclosure. For example, functions etc. included in constituent parts, steps, etc. can be rearranged so as not to logically contradict with each other, and a plurality of constituent parts, steps, etc. can be combined into one or divided.

For example, an embodiment in which the components and operation of the control device 20 according to the above embodiment are distributed to a plurality of mutually communicable computers is also possible. In addition, an embodiment in which a part or all of the constituent elements of the control device 20 are provided in the ship 10 or the portable terminal 30 is also possible, for example. For example, the function of displaying information may be distributed to display devices provided in the ship 10, the control device 20, and the portable terminal 30.

In addition, an embodiment in which a general-purpose computer is caused to function as the control device 20 according to the above embodiment is also possible, for example. Specifically, a program that describes the content of a process that implements the function of the control device 20 according to the above embodiment is stored in a memory of the general-purpose computer, and the program is read and executed by a processor. Thus, the present disclosure can also be implemented as a program that is executable by a processor or a non-transitory computer-readable medium that stores the program.

The following exemplifies a part of the embodiment of the present disclosure. However, the embodiment of the present disclosure is not limited thereto.

What is claimed is:

1. A control device mounted on a ship, comprising a control unit, wherein:
the control unit is configured to set a first water area in which automatic pilot for berthing the ship at a berthing location for the ship is able to start when the berthing location is selected; and
the control unit is configured to display the berthing location and the first water area on a display screen provided in the ship together with map information.

2. The control device according to claim 1, wherein:
the control unit is configured to acquire information on a position of the ship and a stem direction of the ship;
the control unit is configured to extract, based on the information, one or more registered locations at which the ship is able to be berthed; and
the control unit is configured to display the one or more registered locations on the display screen.

3. The control device according to claim 2, wherein the control unit is configured to accept that the berthing location is selected when one of the one or more registered locations is selected as the berthing location for the ship.

4. The control device according to claim 1, wherein:
the first water area is a water area defined such that, when a first circle is equally divided into two semicircles by a line parallel to a stem direction of the ship berthed on a starboard side or on a port side, a range of the water area occupies an inside of one of the two semicircles on a sea side;
the first circle is a circle having a predetermined radius and centered at a location that is a predetermined distance away in a first direction from the berthing location; and
the first direction is a direction on the sea side and orthogonal to the stem direction.

5. The control device according to claim 1, wherein:
the control unit is configured to set a second water area when an obstacle is detected in the first water area;
the second water area is obtained by removing a region in which the obstacle is present from the first water area; and
the control unit is configured to display the set second water area on the display screen in place of the first water area.

6. The control device according to claim 5, wherein:
the obstacle is an artificial structure, a region in which berthing is topographically or legally not allowed, or an object that is detected by a sensor provided in the ship and that obstructs navigation of the ship; and
the artificial structure includes a pier, a quay, or a buoy displayed on the display screen.

7. The control device according to claim 5, wherein:
the control unit is configured to set a part of the first water area or a part of the second water area as a third water area in which the automatic pilot is started;
the part of the first water area or the part of the second water area is determined according to a stem direction of the ship with the ship berthed; and
the control unit is configured to display the third water area on the display screen in place of the first water area or the second water area.

8. The control device according to claim 7, wherein:
the third water area is a water area defined such that, when a fourth water area is equally divided into two quadrants by a line segment, a range of the water area occupies an inside of one of the two quadrants on a stern side;
the fourth water area is a water area defined such that, when a first circle is equally divided into two semicircles by a line parallel to the stem direction with the ship berthed on a starboard side or on a port side, a range of the water area occupies an inside of one of the two semicircles on a sea side;
the first circle is a circle having a predetermined radius and centered at a location a predetermined distance away in a first direction from the berthing location;
the first direction is a direction on the sea side and orthogonal to the stem direction; and
the line segment passes through the berthing location and is orthogonal to the stem direction with the ship berthed.

9. The control device according to claim 7, wherein the third water area is determined according to whether the ship is berthed at the berthing location on a starboard side or on a port side.

10. The control device according to claim 1, wherein the control unit is configured to display a position of the ship and a stem direction of the ship on the display screen together with the map information.

11. A control method executed by a control device mounted on a ship, comprising:
setting a first water area in which automatic pilot for berthing the ship at a berthing location for the ship is able to start when the berthing location is selected; and
displaying the berthing location and the first water area on a display screen provided in the ship together with map information.

12. The control method according to claim 11, further comprising:
acquiring information on a position of the ship and a stem direction of the ship;
extracting, based on the information, one or more registered locations at which the ship is able to be berthed; and
displaying the one or more registered locations on the display screen.

13. The control method according to claim 12, further comprising accepting that the berthing location is selected when one of the one or more registered locations is selected as the berthing location for the ship.

14. The control method according to claim 11, wherein:
the first water area is a water area defined such that, when a first circle is equally divided into two semicircles by a line parallel to a stem direction of the ship berthed on a starboard side or on a port side, a range of the water area occupies an inside of one of the two semicircles on a sea side;
the first circle is a circle having a predetermined radius and centered at a location that is a predetermined distance away in a first direction from the berthing location; and
the first direction is a direction on the sea side and orthogonal to the stem direction.

15. The control method according to claim 11, further comprising:
setting a second water area when an obstacle is detected in the first water area; and
displaying the set second water area on the display screen in place of the first water area, wherein the second water area is obtained by removing a region in which the obstacle is present from the first water area.

16. The control method according to claim 15, wherein:
the obstacle is an artificial structure, a region in which berthing is topographically or legally not allowed, or an object that is detected by a sensor provided in the ship and that obstructs navigation of the ship; and
the artificial structure includes a pier, a quay, or a buoy displayed on the display screen.

17. The control method according to claim 15, further comprising:
setting a part of the first water area or a part of the second water area as a third water area in which the automatic pilot is started; and
displaying the third water area on the display screen in place of the first water area or the second water area, wherein the part of the first water area or the part of the second water area is determined according to a stem direction of the ship with the ship berthed.

18. The control method according to claim 17, wherein:
the third water area is a water area defined such that, when a fourth water area is equally divided into two quadrants by a line segment, a range of the water area occupies an inside of one of the two quadrants on a stern side;
the fourth water area is a water area defined such that, when a first circle is equally divided into two semicircles by a line parallel to the stem direction with the ship berthed on a starboard side or on a port side, a range of the water area occupies an inside of one of the two semicircles on a sea side;
the first circle is a circle having a predetermined radius and centered at a location a predetermined distance away in a first direction from the berthing location;
the first direction is a direction on the sea side and orthogonal to the stem direction; and
the line segment passes through the berthing location and is orthogonal to the stem direction with the ship berthed.

19. The control method according to claim 17, wherein the third water area is determined according to whether the ship is berthed at the berthing location on a starboard side or on a port side.

20. The control method according to claim 11, wherein the control device displays a position of the ship and a stem direction of the ship on the display screen together with the map information.
